(19) United States
(12) Patent Application Publication
(10) Pub. No.: US 2023/0189401 A1
(43) Pub. Date: Jun. 15, 2023

(54) HEATING BODY AND AEROSOL-GENERATION DEVICE INCLUDING SAME

(71) Applicant: SHENZHEN FIRST UNION TECHNOLOGY CO., LTD., Shenzhen City, Guangdong Province (CN)

(72) Inventors: ZUQIANG QI, Shenzhen City, Guangdong Province (CN); BAOLING LEI, Shenzhen City, Guangdong Province (CN); JIAMAO LUO, Shenzhen City, Guangdong Province (CN); ZHONGLI XU, Shenzhen City, Guangdong Province (CN); YONGHAI LI, Shenzhen City, Guangdong Province (CN)

(21) Appl. No.: 17/923,898

(22) PCT Filed: May 6, 2021
(86) PCT No.: PCT/CN2021/091946

§ 371 Date: Nov. 7, 2022

(30) Foreign Application Priority Data
May 6, 2020 (CN) 202020720254.1

(51) Int. Cl. H05B 3/00; A24F 40/20; A24F 40/46

(52) U.S. Cl. CPC H05B 3/0033; A24F 40/20; A24F 40/46; H05B 2203/032; H05B 2203/016

(57) ABSTRACT

A heating body and an aerosol-generation device including the heating body are disclosed. The heating body includes: an electric heating element, configured to receive electric power of a power supply to generate heat; a base body, configured for insertion into the aerosol-forming substrate, where an accommodating cavity is formed inside the base body, and the accommodating cavity is configured to accommodate the electric heating element; and an infrared radiator, arranged on the base body in heat conduction with the electric heating element, where the infrared radiator is configured to receive the heat generated by the electric heating element, heat up to generate infrared rays, and heat the aerosol-forming substrate at least in a radiation manner. Infrared radiation has certain penetrability, and has a good heating effect on a cigarette, so that components in the cigarette can be fully released, thereby improving the inhaling experience of users.

### CROSS-REFERENCE TO RELATED APPLICATIONS

This application claims priority to Chinese Patent Application No. 202020720254.1, filed with the China National Intellectual Property Administration on May 6, 2020 and entitled “HEATING BODY AND AEROSOL-GENERATION DEVICE INCLUDING SAME”, which is incorporated herein by reference in its entirety.

### TECHNICAL FIELD

This application relates to the field of cigarette device technologies, and in particular, to a heating body and an aerosol-generation device including the heating body.

### BACKGROUND

During use of smoking items such as cigarettes and cigars, tobacco is burnt to generate smoke. Attempts have been made to provide substitutes for these tobacco-burning items by producing products that release compounds without burning. An example of such a product is a so-called heat-not-burn product which releases a compound by heating instead of burning tobacco.

The existing aerosol-generation device uses a ceramic heating body to heat a cigarette. Specifically, a heating wire is arranged in a ceramic tube. After the heating wire is energized, heat generated is conducted to the ceramic tube, and the ceramic tube further heats the cigarette. The aerosol-generation device has the following problems: a poor heating effect of the ceramic heating body, insufficient release of components in the cigarette, and poor inhaling experience of users.

### SUMMARY

Embodiments of this application aim to provide a heating body and an aerosol-generation device including the heating body, to solve the problem of the poor heating effect of the heating body in the related art.

An aspect of this application provides a heating body. The heating body is configured to heat an aerosol-forming substrate to generate an aerosol, and includes:

an electric heating element, configured to receive electric power of a power supply to generate heat;

a base body, configured for insertion into the aerosol-forming substrate, where an accommodating cavity is formed inside the base body, and the accommodating cavity is configured to accommodate the electric heating element; and

an infrared radiator, arranged on the base body in heat conduction with the electric heating element, where the infrared radiator is configured to receive the heat generated by the electric heating element, heat up to generate infrared rays, and heat the aerosol-forming substrate at least in a radiation manner.

Another aspect of this application provides an aerosol-generation device. The aerosol-generation device includes a heating chamber and a heating body arranged in the heating chamber.

According to the heating body and the aerosol-generation device including the heating body provided in this application, the infrared radiator receives the heat generated by the electric heating element, heats up to generate infrared rays, and heats the aerosol-forming substrate at least in a radiation manner. Infrared radiation has certain penetrability, and has a good heating effect on a cigarette, so that components in the cigarette can be fully released, thereby improving the inhaling experience of users.

### BRIEF DESCRIPTION OF THE DRAWINGS

One or more embodiments are exemplarily described with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic diagram of a heating body according to an embodiment of this application.

FIG. 2 is a schematic exploded view of a heating body according to an embodiment of this application.

FIG. 3 is a schematic cross-sectional view of a heating body according to an embodiment of this application.

FIG. 4 is a schematic diagram of a keeping member according to an embodiment of this application.

FIG. 5 is a schematic diagram of a base body according to an embodiment of this application.

FIG. 6 is a schematic diagram of a bottom base according to an embodiment of this application.

FIG. 7 is a schematic diagram of another bottom base according to an embodiment of this application.

FIG. 8 is a schematic diagram of an aerosol-generation device according to an embodiment of this application.

### DETAILED DESCRIPTION

It is to be understood that the specific embodiments described herein are merely used for explaining this application but are not intended to limit this application. For ease of understanding of this application, this application is described below in more detail with reference to accompanying drawings and specific implementations. It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. The terms “upper”, “lower”, “left”, “right”, “inside”, “outside” and similar expressions used in this specification are merely used for an illustrative purpose.

Unless otherwise defined, meanings of all technical and scientific terms used in this specification are the same as those usually understood by a person skilled in art of this application. Terms used in this specification of this application are merely intended to describe objectives of the specific implementations, and are not intended to limit this application. A term “and/or” used in this specification includes any or all combinations of one or more related listed items.

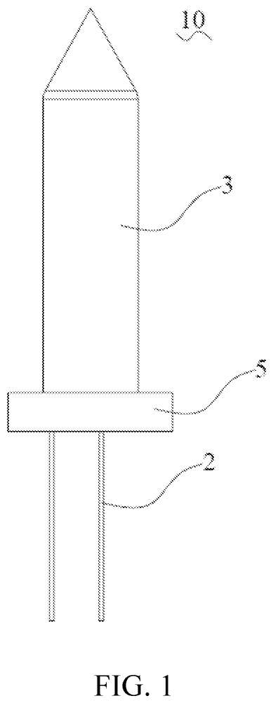

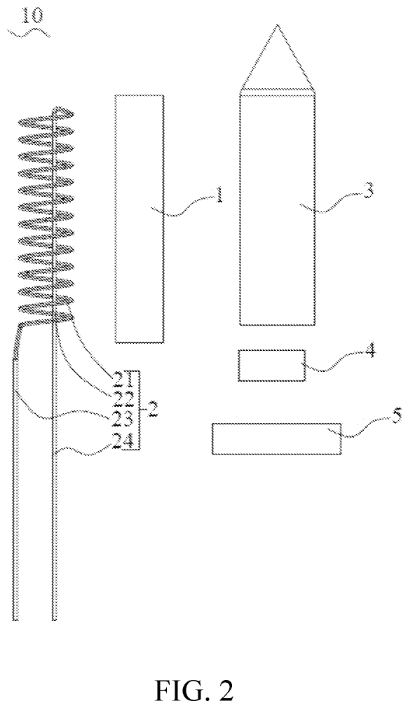

Referring to FIG. 1 to FIG. 3, an embodiment of this application provides a heating body 10. The heating body 10 is configured to heat an aerosol-forming substrate to generate an aerosol, and includes a keeping member 1, an electric heating element 2, a base body 3, a seal member 4, a bottom base 5, and an infrared radiator 6.

The keeping member 1 is configured to keep the electric heating element 2 fixed; and the electric heating element 2 is configured to receive electric power of a power supply to generate heat.

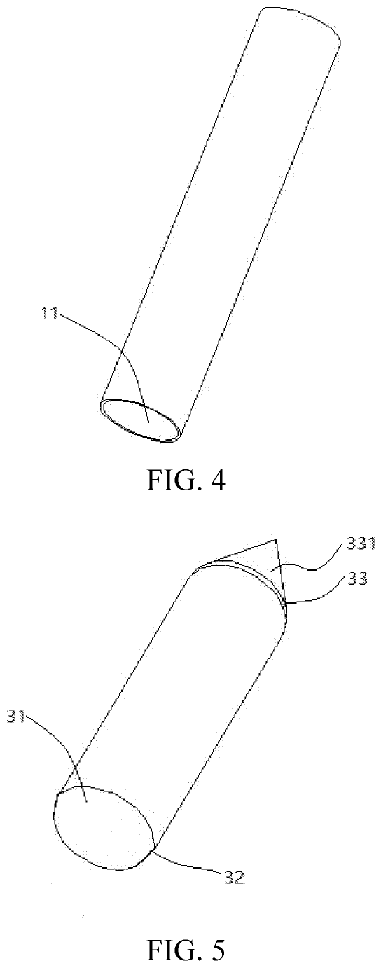

As shown in FIG. 4, in this embodiment, the keeping member 1 is a cylindrical tube, the keeping member 1 is hollow inside, and both ends of the keeping member 1 are open to form an inner hole 11. The electric heating element 2 includes at least a spiral section 21 arranged on an outer surface of the keeping member 1, and an extension section 22 located in the inner hole 11 and extending along an axial direction of the keeping member 11. Further, the spiral section 21 and the extension section 22 of the electric heating element 2 overlap at least partially in the axial direction of the keeping member 1, so that the spiral section 21 wound on the outer surface of the keeping member 1 has a large heating area and can generate heat uniformly, and the extension section 22 of the electric heating element 2 located in the inner hole 11 of the keeping member 1 can also generate heat, to increase the amount of heat generated and ensure adequate heat supply. Because there is no electrical contact in the electric heating element 2 due to the arrangement of the spiral section 21 and the extension section 22, a short circuit in the electric heating element 2 can be avoided after the electric heating element 2 receives power.

In this embodiment, a material of the keeping member 1 may be a high-temperature resistant insulating material such as ceramics, alumina, zirconia, magnesium oxide, and silicon oxide, which is not specifically limited. When a material of the electric heating element 2 is selected, the following factors may be referred to: 1) high resistivity, a size meeting requirements, a relatively large infrared radiation area, and high radiation efficiency; and 2) relatively stable in the air, and not oxidizing when heated to 180° C. to 350° C. Specifically, a tungsten wire, a nickel chrome wire, an iron chrome aluminum wire, a titanium wire, a nickel wire, a nickel iron alloy wire, carbon fiber, and the like may be selected; and preferably, the nickel chrome wire and the titanium wire are selected. When the titanium wire is selected, the electric heating element 2 can not only be used as a resistor to receive the electric power of the power supply to generate heat, but also be used as a temperature sensor.

In another example, the keeping member 1 may be alternatively a sheet, and the sheet keeping member 1 keeps the electric heating element 2 fixed and isolates the electric heating element 2 to prevent a short circuit after the electric heating element 2 receives power. For example, the alumina material is selected and cut into a sheet, and the electric heating element 2 is arranged on the sheet alumina.

In another example, the keeping member 1 may be alternatively a high-temperature resistant insulating powder material, such as magnesium oxide powder, silica powder, and alumina powder. The insulating powder material may be filled in an accommodating cavity 31 of the base body 3 to keep the electric heating element 2 fixed, and isolate the electric heating element 2 to prevent a short circuit after the electric heating element 2 receives power.

The base body 3 is configured for insertion into the aerosol-forming substrate, for example, insert into a cigarette. The base body 3 may be made of a material that is resistant to high temperature and has high infrared transmittance, including but not limited to the following materials: quartz glass, sapphire, silicon carbide, magnesium fluoride ceramics, yttrium oxide ceramics, magnesium aluminate spinel ceramics, yttrium alumina garnet single crystal, germanium single crystal, and the like. Preferably, the base body 3 is made of the quartz glass. The quartz glass has low surface free energy, and smoke residue does not easily adhere to an outer surface of the quartz glass, so that the quartz glass is easy to clean. The base body 3 may be further made of materials such as metal and alloy.

The aerosol-forming substrate is a substrate that can release a volatile compound that can form an aerosol. The volatile compound can be released by heating the aerosol-forming substrate. The aerosol-forming substrate may be solid, or liquid, or components including solid and liquid. The aerosol-forming substrate may be loaded onto a carrier or support through adsorbing, coating, impregnating, or in other manners.

The aerosol-forming substrate may include nicotine. The aerosol-forming substrate may include tobacco, for example, a tobacco-containing material including a volatile tobacco aroma compound. The volatile tobacco aroma compound is released from the aerosol-forming substrate when heated. A preferred aerosol-forming substrate may include a homogeneous tobacco material, for example, deciduous tobacco. The aerosol-forming substrate may include at least one aerosol-forming agent, and the aerosol-forming agent may be any suitable known compound or a mixture of compounds. During use, the compound or the mixture of compounds facilitates stabilizing formation of the aerosol and is substantially resistant to thermal degradation at an operating temperature of an aerosol-forming system. Suitable aerosol-forming agents are well known in the related art and include, but are not limited to: polyol, such as triethylene glycol, 1, 3-butanediol, and glycerol; ester of polyol, such as glycerol mono-, di- or triacetate; and fatty acid ester of mono-, di- or polycarboxylic acid, such as dimethyl dodecanedioate and dimethyl tetradecanedioate. A preferred aerosol-forming agent is polyhydric alcohol or a mixture thereof, such as triethylene glycol, 1, 3-butanediol, and most preferred glycerol.

As shown in FIG. 5, in this embodiment, the base body 3 is columnar, preferably cylindrical. The accommodating cavity 31 is formed inside the hollow base body 3, and the accommodating cavity 31 is configured to accommodate the keeping member 1 and the electric heating element 2. A length of the accommodating cavity 31 is equal to or slightly greater than a length of the keeping member 1, to ensure that the keeping member 1 can be completely accommodated in the accommodating cavity 31. A shape of the accommodating cavity 31 matches a shape of the base body 3, to limit the keeping member 1 and ensure that the electric heating element 2 is kept at a proper position of the accommodating cavity 31.

The base body 3 includes an open end 32 and a closed end 33. The keeping member 1 and the electric heating element 2 are placed into the accommodating cavity 31 from the open end 32. The spiral section 21 of the electric heating element 2 is located between the base body 3 and the keeping member 1. An electrode connecting end of the electric heating element 2 extends out of the base body 3 from the open end 32. Specifically, the heating body 10 further includes a first pin wire 23 and a second pin wire 24; and one end of the first pin wire 23 is connected to the spiral section 21, one end of the second pin wire 24 is connected to the extension section 22, and an other end of the first pin wire 23 and an other end of the second pin wire 24 both extend out of the base body 3 from the open end 32. The pin wires and the electric heating element 2 may be fixedly connected through argon arc welding or laser welding.

In this embodiment, a connection point between the one end of the first pin wire 23 and the spiral section 21 is a first connection point (not shown in the accompanying drawings), and a connection point between the one end of the second pin wire 24 and the extension section 22 is a second connection point (not shown in the accompanying drawings). Both the first connection point and the second connection point are located in the accommodating cavity 31. Specifically, a distance between the first connection point and the open end 32 is a first distance, a distance between the second connection point and the open end 32 is a second distance, and a smaller distance of the first distance and the second distance is between 1 mm and 3 mm. With such arrangement, when the base body 3 is inserted into a cigarette, a height from 1 mm to 3 mm at the bottom of the cigarette is not heated, so that cut tobacco at the bottom is kept in a relatively complete shape in an inhaling and using process of the cigarette, which prevents cut tobacco residue from falling into a heating chamber 20 in a cigarette extraction process, and keeps the heating chamber 20 in a relatively clean state.

In this embodiment, the first pin wire 23 and the second pin wire 24 may be made of a material with low resistivity, for example, a nickel wire. The nickel wire has good corrosion resistance and oxidation resistance.

It should be noted that, in this embodiment, the spiral section 21 and the extension section 22, the spiral section 21 and the second pin wire 24, the extension section 22 and the first pin wire 23, and the first pin wire 23 and the second pin wire 24 are all isolated through the keeping member 1 to prevent a short circuit after power is received.

In this embodiment, a protruding portion 331 protrudes at the closed end 33. The protruding portion 331 is tapered, and the protruding portion 331 is formed by extending of the base body 3 from the closed end 33. With the arrangement of the protruding portion 331, the base body 3 can be conveniently inserted into the cigarette and a contact area between the base body 3 and the cigarette can be increased. Preferably, the protruding portion 331 is hollow inside and in communication with the accommodating cavity 31, so that heat generated by the electric heating element 2 is better conducted to the cigarette through the protruding portion 331, to avoid uneven heating of the cigarette at the protruding portion 331, which affects baking of the cigarette.

Further, after the electric heating element 2 and the keeping member 1 are inserted into the accommodating cavity 31 of the base body 3, the open end 32 may be sealed by using the seal member 4, so that the electric heating element 2 and the keeping member 1 are stably arranged in the base body 3, and heat loss inside the heating body is reduced. The seal member 4 may be made of materials such as magnesium oxide, silicon oxide, and alumina for sealing and insulating.

In this embodiment, the heating body 10 further includes a bottom base 5. An end surface of the open end 32 of the base body 3 abuts against the bottom base 5, and the first pin wire 23 and the second pin wire 24 pass through the seal member 4 and the bottom base 5. The bottom base 5 may be made of a ceramic material with low thermal conductivity, for example, zirconia, to prevent heat conduction and reduce temperature of a shell of the aerosol-generation device.

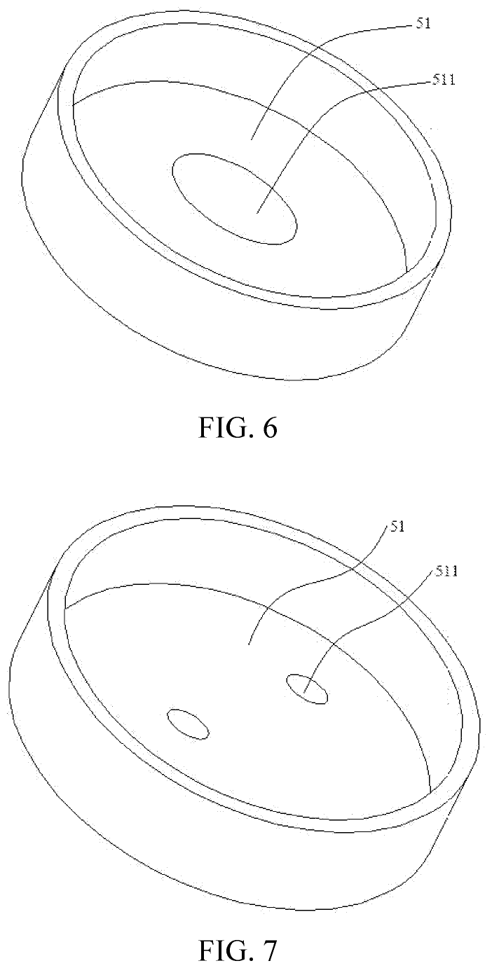

Specifically, the bottom base 5 is cylindrical, and may be cylindrical, quadrangular, hexagonal, and the like. An accommodating groove 51 is concavely provided on the bottom base 5, the open end 32 of the base body 3 is fixed in the accommodating groove 51, and a through hole 511 through which the first pin wire 23 and the second pin wire 24 pass is provided at the bottom of the accommodating groove 51. Further, the keeping member 1 may abut against the bottom of the accommodating groove 51 to limit the keeping member 1 at a central position in the base body 3, so that the electric heating element 2 can be evenly distributed in the base body 3, which is conducive to uniform heating of the cut tobacco. As shown in FIG. 6, the through hole 511 may be a circular hole with a diameter smaller than that of the keeping member 1, to ensure that the keeping member 1 does not slide into the through hole 511 when abutting against the bottom of the accommodating groove 51. As shown in FIG. 7, the through holes 511 may be alternatively two circular holes with a diameter slightly larger than that of the electric heating element 2, and the first pin wire 23 and the second pin wire 24 respectively pass through the two circular holes, to facilitate connection to an external power supply.

The infrared radiator 6 is configured to receive the heat generated by the electric heating element 2, heat up to generate infrared rays, and heat the aerosol-forming substrate at least in a radiation manner. Infrared radiation has certain penetrability, and has a good heating effect on a cigarette, so that components in the cigarette can be fully released, thereby improving the inhaling experience of users.

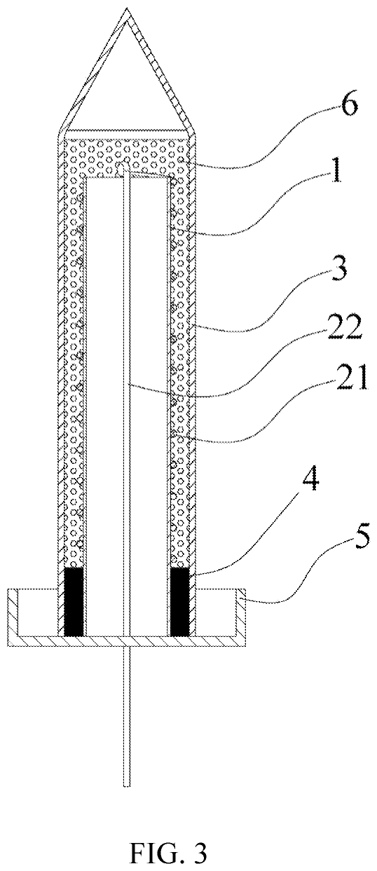

Referring to FIG. 3, in this embodiment, the infrared radiator 6 is an infrared radiation powder material filled in the accommodating cavity. The infrared radiator 6 may be made of materials with high infrared emissivity such as an oxide, a carbon material, a carbide, and a nitride. Specifically, as shown below,

metal oxides and multicomponent alloy oxides include: ferric oxide, aluminum oxide, chromium trioxide, indium oxide, lanthanum oxide, cobalt oxide, nickel oxide, diantimony trioxide, antimony pentoxide, titanium dioxide, zirconia, manganese dioxide, cerium oxide, copper oxide, zinc oxide, magnesium oxide, calcium oxide, molybdenum trioxide, and the like; or a combination of the foregoing two or more metal oxides; or a ceramic material having a unit cell structure such as spinel, perovskite, and olivine.

The carbon material has emissivity close to a blackbody characteristic and has high infrared emissivity. The carbon material includes: graphite, carbon fiber, carbon nanotubes, graphene, diamond-like carbon film, and the like.

The carbide includes: silicon carbide. The silicon carbide has high emissivity in a large infrared wavelength range (2.3 microns to 25 microns), and is a good near-full-band infrared radiation material. In addition, tungsten carbide, iron carbide, vanadium carbide, titanium carbide, zirconium carbide, manganese carbide, chromium carbide, niobium carbide, and the like all have high infrared emissivity (MeC phase does not have strict chemical calculation component and chemical formula).

The nitride includes: a metal nitride and a non-metal nitride. The metal nitride includes: titanium nitride, titanium carbonitride, aluminum nitride, magnesium nitride, tantalum nitride, vanadium nitride, and the like. The non-metallic nitride includes: boron nitride, triphosphorus pentanitride, silicon nitride (Si3N4), and the like.

Other inorganic nonmetallic materials include: silica, silicate (including phosphosilicate, borosilicate, and the like), titanate, aluminate, phosphate, boride, chalcogenide, and the like.

In another example, the infrared radiator 6 may be an infrared radiation film layer formed on an outer surface of the base body 3 and may be formed on the outer surface of the base body 3 through physical vapor deposition. In this case, the base body 3 may be made of materials such as metal and alloy.

Further, a glaze layer may be further provided on the outer surface of the base body 3. The glaze layer may protect the infrared radiation film layer and prevent the infrared radiation film layer from being scratched.

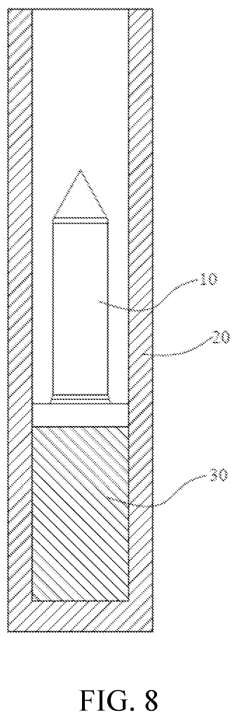

Referring to FIG. 8, the embodiments of this application further provide an aerosol-generation device. The aerosol-generation device includes a heating chamber 20 and a heating body 10 arranged in the heating chamber 20. The aerosol-generation device further includes a battery 30. The heating body 10 is electrically connected to the battery 30, and the battery 30 supplies electric power to the electric heating element 2 to generate heat. The battery 30 may be, but is not limited to, a lithium iron phosphate (LiFePO4) battery. For example, the battery 30 may be a lithium cobaltate (LiCoO2) battery or a lithium titanate battery. The battery 30 may be a rechargeable battery or a disposable battery.

According to the heating body 10 and the aerosol-generation device including the heating body 10 provided in the embodiments of this application, the infrared radiator receives the heat generated by the electric heating element, heats up to generate infrared rays, and heats the aerosol-forming substrate at least in a radiation manner. Infrared radiation has certain penetrability, and has a good heating effect on a cigarette, so that components in the cigarette can be fully released, thereby improving the inhaling experience of users.

It should be noted that, this specification of this application and the accompanying drawings thereof illustrate preferred embodiments of this application. However, this application can be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the foregoing technical features are further combined to form various embodiments not listed above, and all such embodiments shall be construed as falling within the scope of this application. Further, a person of ordinary skill in the art may make improvements or modifications according to the foregoing description, and all the improvements and modifications shall fall within the protection scope of the attached claims of this application.

1. A heating body, configured to heat an aerosol-forming substrate to generate an aerosol, and comprising:
an electric heating element, configured to receive electric power of a power supply to generate heat;
a base body, configured for insertion into the aerosol-forming substrate, wherein an accommodating cavity is formed inside the base body, and the accommodating cavity is configured to accommodate the electric heating element; and
an infrared radiator, arranged on the base body in heat conduction with the electric heating element, wherein the infrared radiator is configured to receive the heat generated by the electric heating element, heat up to generate infrared rays, and heat the aerosol-forming substrate at least in a radiation manner.

2. The heating body according to claim 1, wherein the infrared radiator is an infrared radiation film layer formed on an outer surface of the base body; and/or, the infrared radiator is an infrared radiation powder material filled in the accommodating cavity.

3. The heating body according to claim 1, wherein a shape of the accommodating cavity matches a shape of the base body.

4. The heating body according to claim 3, wherein the base body comprises a closed end and an open end, and the electric heating element is accommodated in the accommodating cavity from the open end.

5. The heating body according to claim 4, wherein the heating body further comprises a first pin wire and a second pin wire; and
one end of the first pin wire is connected to one end of the electric heating element, one end of the second pin wire is connected to an other end of the electric heating element, and an other end of the first pin wire and an other end of the second pin wire both extend out of the base body from the open end.

6. The heating body according to claim 5, wherein a connection point between the one end of the first pin wire and the one end of the electric heating element is a first connection point, a connection point between the one end of the second pin wire and the other end of the electric heating element is a second connection point, and both the first connection point and the second connection point are located in the accommodating cavity.

7. The heating body according to claim 6, wherein a distance between the first connection point and the open end is a first distance, a distance between the second connection point and the open end is a second distance, and a smaller distance of the first distance and the second distance is between 1 mm and 3 mm.

8. The heating body according to claim 7, wherein the heating body further comprises a seal member, and the seal member is configured to seal the open end.

9. The heating body according to claim 8, wherein the heating body further comprises a bottom base, and an end surface of the open end abuts against the bottom base.

10. The heating body according to claim 4, wherein a protruding portion is arranged at the closed end, the protruding portion is tapered, and the protruding portion is formed by extending of the base body from the closed end.

11. The heating body according to claim 1, wherein the heating body further comprises a keeping member, the keeping member is configured to keep the electric heating element fixed, and the keeping member is accommodated in the accommodating cavity of the base body.

12. The heating body according to claim 11, wherein the keeping member is hollow inside and both ends of the keeping member are open to form an inner hole, and the electric heating element comprises at least a spiral section arranged on an outer surface of the keeping member, and an extension section located in the inner hole.

13. The heating body according to claim 1, wherein a material of the infrared radiator is selected from at least one of an oxide, a carbon material, a carbide, and a nitride.

14. The heating body according to claim 1, wherein a material of the base body is selected from at least one of metal, alloy, quartz glass, sapphire, silicon carbide, magnesium fluoride ceramics, yttrium oxide ceramics, magnesium aluminate spinel ceramics, yttrium alumina garnet single crystal, and germanium single crystal.

15. An aerosol-generation device, comprising: a heating chamber and the heating body according to claim 1 arranged in the heating chamber.

16. The heating body according to claim 2, wherein a shape of the accommodating cavity matches a shape of the base body.

17. The heating body according to claim 16, wherein the base body comprises a closed end and an open end, and the electric heating element is accommodated in the accommodating cavity from the open end.

18. The heating body according to claim 17, wherein the heating body further comprises a first pin wire and a second pin wire; and
one end of the first pin wire is connected to one end of the electric heating element, one end of the second pin wire is connected to an other end of the electric heating element, and an other end of the first pin wire and an other end of the second pin wire both extend out of the base body from the open end.

19. The heating body according to claim 18, wherein a connection point between the one end of the first pin wire and the one end of the electric heating element is a first connection point, a connection point between the one end of the second pin wire and the other end of the electric heating element is a second connection point, and both the first connection point and the second connection point are located in the accommodating cavity.

20. The heating body according to claim 17, wherein a protruding portion is arranged at the closed end, the protruding portion is tapered, and the protruding portion is formed by extending of the base body from the closed end.
